(19) United States
(12) Patent Application Publication
(10) Pub. No.: US 2026/0270594 A1
(43) Pub. Date: Sep. 10, 2026

(54) SYNCHRONIZATION OF EVENTS IN IOT DEVICES

(71) Applicant: Volley Boast, LLC, Houston, TX (US)

(72) Inventors: Thomas A. Volpe, Austin, TX (US); Milan Vujovic, Belgrade (RS)

(73) Assignee: Volley Boast, LLC, Houston, TX (US)

(21) Appl. No.: 19/167,023

(22) PCT Filed: Mar. 20, 2024
(86) PCT No.: PCT/US2024/020687

§ 371 Date: Sep. 19, 2025

Related U.S. Application Data
(60) Provisional application No. 63/577,051, filed on Mar. 24, 2023.

(51) Int. Cl. H04Q 9/04; H04W 4/38; H04W 52/02

(52) U.S. Cl. CPC H04Q 9/04; H04W 4/38; H04W 52/0258; H04Q 2209/43

(57) ABSTRACT

Events at Internet of Things (IoT) devices can be synchronized. A measurement configuration may be received at IoT devices to synchronize respective sensor measurements captured by the IoT devices according to an absolute time reference. The measurement configuration may include a configuration period, measurement period, and transmit period. Capture of sensor measurements can then be performed, executing configuration instructions within the configuration period to prepare the devices to capture the sensor measurement, executing measurement capture instructions to capture the sensor measurement, starting at a measurement start time determined based on the absolute time reference and the configuration period, and wirelessly transmitting the sensor measurement to a recipient device within the transmit period.

### PRIORITY CLAIM

This application is a 371 of PCT Application No. PCT/US2024/020687, filed Mar. 20, 2024, which claims benefit of priority to U.S. Provisional Patent Application No. 63/557,051, filed Mar. 24, 2024. The above applications are incorporated herein by reference. To the extent that any material in the incorporated application conflicts with material expressly set forth herein, the material expressly set forth herein controls.

### BACKGROUND

Internet of Things (IoT) provides the opportunity to integrate multiple systems, devices, or locations across one or more networks. Multiple IoT devices can communicate various information in order to facilitate collective performance of various tasks, such as monitoring or automation, among others. Different techniques have been developed to coordinate the performance of these tasks.

### BRIEF DESCRIPTION OF THE FIGURES

FIG. 1 illustrates an example network where IoT devices can have events synchronized, according to some embodiments.

FIG. 2 illustrates an example time line of events in the execution of two IoT devices and a Gateway in a network, according to some embodiments.

FIG. 3 illustrates an example detailed time line of events in the execution of two IoT devices where some events have been synchronized to an Absolute Time Reference, according to some embodiments.

FIG. 4 illustrates an example detailed time line of events in the execution of two IoT devices where sensor measurements and packet transmissions have been synchronized to an Absolute Time Reference, according to some embodiments.

FIG. 5 illustrates an example time line of events in the execution of a single IoT device where local time is re-synchronized to the network time regularly, according to some embodiments.

FIGS. 6A and 6B illustrate example interactions for providing device measurement, configuration, and transmission times to IoT devices, according to some embodiments.

FIG. 7 illustrates an example of a process where synchronization settings can be determined in order to synchronize events on multiple IoT devices, according to some embodiments.

FIG. 8 illustrates an example of an IoT device according to certain aspects of the disclosure, according to some embodiments.

### DETAILED DESCRIPTION

An IoT device can have hardware to connect to one or more different types of sensors (such as thermocouples, level sensors, distance sensors, pressure sensors, flow sensors, switch position sensors, etc) or interfaces to sensors or data (such as ModBus, CAN bus, etc.). The software or firmware running on the IoT device can configure itself to take one or more sensor measurements directly from sensors or through an interface to the sensors, and then can communicate the sensor measurements over a network so that an operator in a remote location can see the sensor readings. In various embodiments, the network that the IoT device communicates over may be a wired network (such as Ethernet or Token Ring) or a wireless network (such as LoraWAN, WIFI, Bluetooth, Satellite, etc.).

A large system (such as a chemical plant, an oil refinery, an oil field, a warehouse, etc.) can have 100s or 1000s of sensors. The sensors for one large system may be physically distributed over a large area with sensors being multiple yards or even miles apart and a wired or wireless network can allow communication of sensor measurements back to an operator. The sensor measurements taken together may give the operator insight into the total performance or condition of the system.

Some types of networks allow IoT devices connected to the network to communicate or transmit data on the network at any time. However, when multiple IoT devices transmit data on the network at the same time, their transmissions can collide, causing one or multiple ones of the transmissions not to be received by listening devices on the network. When collisions occur on the network, IoT devices may wait a random period of time before transmitting the same data again. IoT devices can use a significant amount of power when they transmit on the network. For battery powered IoT devices, the effect of re-transmissions to send a single piece of data, can cause the IoT devices to exhaust their battery more quickly (e.g., than if a single transmission were performed).

IoT devices use time for various purposes. IoT devices can use the passage of time or time intervals to determine when certain events should occur, such as when the IoT device should wake up and perform its functions, such as taking sensor measurements and transmitting sensor data over the network, and when the IoT device should go to sleep to conserve power.

In addition, the current time may be used as a timestamp to indicate the exact date and time when a measurement was taken, so that the operator who receives the measurement data knows when the system was in the state indicated by the sensor. A timestamp may be communicated along with the measurement data over the network or a timestamp may be determined by when the measurement data is received over the network.

Generally, IoT devices each maintain time individually. An IoT device can have an internal clock circuit that is driven, for example, by a crystal oscillator. The clock circuit can increment every second, every millisecond, or at some fraction of a second. At any given moment, the clock circuit can provide the current time as a numerical value. The numerical value is typically an offset from what is known as the epoch time, which sets time zero at 12:00 am, Jan. 1, 1970 and the numerical value represents the number of seconds since that epoch time. The IoT device may have the ability to get the current time from the network and update its local time to match the network time. Network devices can be connected to very accurate time references such as from radio wave receivers which get their time from Global Positioning Satellites (GPS).

Various embodiments are described below which provide techniques to ensure the synchronization of events in IoT devices connected to various types of sensors distributed across a large physical area that can take their measurements at a synchronized instant in time (e.g., which may be the exact same time or nearly the exact same time within a guaranteed degree of precision that the measurements can be treated as the exact same for analytical purposes). Such techniques allow for IoT devices to take their measurements at a particular time of day or at a particular interval with respect to an absolute time reference, can have the sensor readings communicated over a network without data collisions, can maintain local time accurately and in sync with IoT devices in the network, and can compute the settings necessary to enable the synchronization. As may be appreciated by one of ordinary skill in the art, such techniques improve the performance of IoT devices and systems which rely upon their measurements to perform tasks. Moreover, as discussed below synchronization allows for the ability to manage the transmission of measurements to avoid collisions, increasing the battery life of IoT devices.

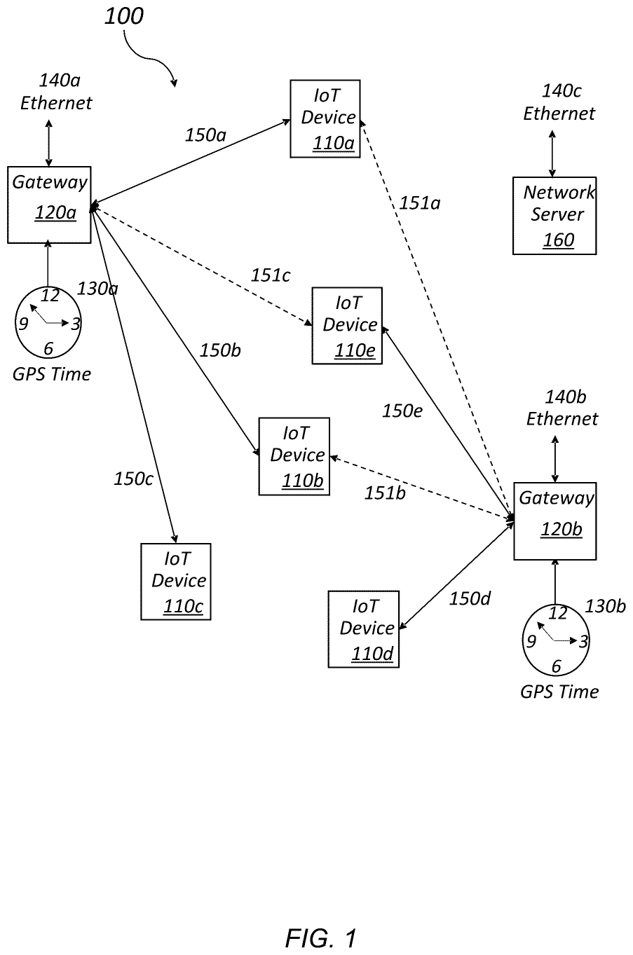

FIG. 1 illustrates an example network where IoT devices can have events synchronized. FIG. 1 illustrates a network 100 in which an architecture and method for synchronization of events in IoT devices can be implemented in various embodiments. The network 100 includes IoT devices 110a-110d, which can communicate with one or more gateways 120a-120b via network links 150a-150c and 151a-151c using a network protocol such as LoRaWAN. The network links provide “downlinks” or packet communications from gateways 120a-120b to IoT devices 110a-110e and “uplinks” or packet communication from IoT devices 110a-110e to gateways 120a-120b. Some network links with the highest signal strength 150a-150d can be treated as the primary means of communication between the IoT devices 110a-110e and a gateway 120a-120b, while others network links with lower signal strength 151a-151c can be treated as secondary or redundant links. Gateways 120a-120b communicate to a network server 160 over a network links 140a-140c using a protocol such as Ethernet. The network server 160 manages the network 100 and steers data to and from IoT devices 110a-110e to other devices (such as operator terminals, control systems, storage servers, etc.) on a LAN or WAN which can be also to the Ethernet network 140c using switches or routers. Gateways 120a-120b can be connected to an accurate time provider 130a-130b such as a radio wave receiver which gets their time from Global Positioning System (GPS) or some other type of accurate time provider such as an atomic clock. Though a small number of IoT devices 110a-110e and gateways 120a-120b are illustrated in this example network 100, other example networks can include hundreds or thousands of IoT devices and tens of gateways distributed over a large physical area.

As discussed above, each IoT device 110a-110e in the example network 100 may individually be maintaining the current time, including the date, hour, minute, second, and/or fraction of a second. The time being maintained internally by an individual device will be referred to herein as the local time. Each gateway 120a-120b may individually be maintaining the current time based on their accurate time providers 130a-130b. The current time at each gateway 120a-120b is highly accurate and assumed to be the exact same time at each gateway 120a-120b for the purposes of this disclosure and will be referred to herein as the network time.

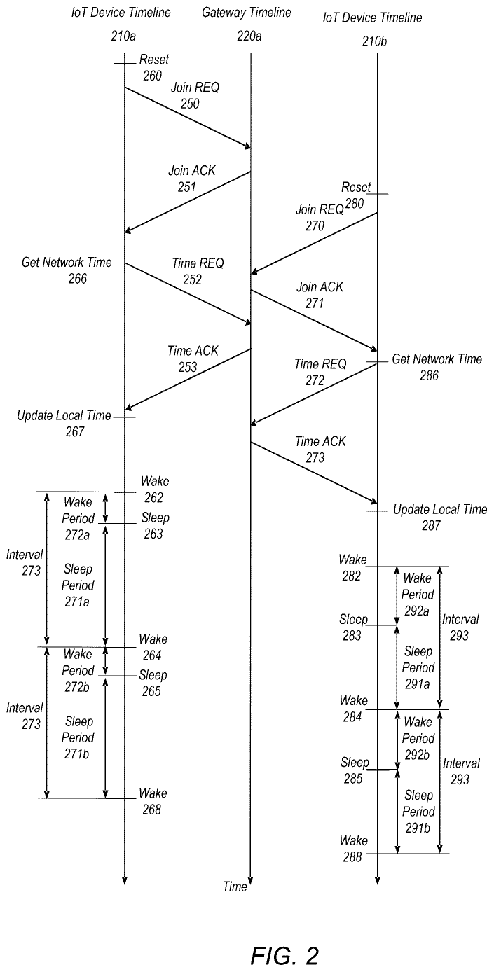

FIG. 2 illustrates the time line of events for a first IoT device 210a, the time line of events for a first gateway 220a, and the time line of events for a second IoT device 210b. For example, the time line of events for a first IoT device 210a could correspond to the events on IoT device 110a from FIG. 1. The time line of events for a first gateway 220a could correspond to the events on gateway 120a from FIG. 1. The time line of events for a second IoT device 210b could correspond to the events on IoT device 110b from FIG. 1.

The time line of events for a first IoT device 210a begins with a Reset event 260 which is the restarting of software execution caused by powering on the device, by pushing a reset button, or by receiving a downlink telling the device to restart software execution. The Reset event 260 is followed in time by IoT device 110a transmitting a Join Request packet 250 to all gateways 120a-120b, requesting to join the network. Gateway 110a responds to the Join Request packet by transmitting a Join Acknowledge packet 251 to IoT device 110a. It should be noted that the gateway which responds is determined by the Network Server 160 and that gateways 120a and 120b are equivalent and part of the same network.

After joining the network, at the time labeled as Get Network Time 266, IoT device 110a transmits a Time Request packet 252 to all gateways 120a-120b, requesting that the network time be sent in the response. Gateway 110a responds to the Time Request packet by transmitting a Time Acknowledge packet 253 which contains the network time. It should be noted that the gateway which responds is determined by the Network Server 160 and that gateways 120a and 120b are equivalent, part of the same network, and provide the same network time in response. At the time labeled as Update Local Time 267, IoT device 110a updates its local time to match the network time. The procedure to update the local time with the network time takes into account the transmission delays of the Time Acknowledge packet 253.

At the time labeled Wake 262, the IoT device 110a “Wakes-Up” or “Wakes” which means it enters its active state to execute software and to utilize its hardware to complete a set of defined tasks. When IoT device 110a is in its active state its set of defined tasks can be to take sensor measurements, to read sensor measurements over interfaces, to write control settings over interfaces, to transmit sensor measurement data as uplinks, to receive downlinks of settings or commands, or to transmit other types of uplinks. The period of time between the time labelled Wake 262 and the time labelled Sleep 263 is the Wake Period 272a.

At the time labeled as Sleep 263, the IoT device enters a low-power sleep mode. Being that IoT devices 110a-110e are typically battery powered, when the IoT device is not actively doing anything, it “Goes to Sleep” or “Sleeps” which means it enters a low-power mode to conserve power. The period of time between the time labelled Sleep 263 and the time labelled Wake 264 is the Sleep Period 271a.

The period of time between the time labelled Wake 262 and the time labelled Wake 264 is the Interval 273 which may also be known as the “Wake Interval.” The Interval 273 is a configuration setting for the IoT device which tells the IoT device how often it is to “Wake-Up” and enter its active state to execute software and utilize its hardware to complete a set of defined tasks. The duration of the Wake Period 272a is the amount of time it takes for the IoT device to execute software and utilize its hardware to complete a set of defined tasks. When the Wake Period 272a ends, software calculates the length of the Sleep Period 271a in order to “Wake-Up” at the end of the Interval 273. The equation for the Sleep Period is: Sleep Period=Interval−Wake Period.

The period of time between the time labelled Wake 264 and the time labelled Sleep 265 is a second Wake Period 272b. The period of time between the time labelled Sleep 265 and the time labelled Wake 268 is a second Sleep Period 271b. The period of time between the time labelled Wake 264 and the time labelled Wake 268 is the Interval 273. The duration of Wake Period 272b can be different than Wake Period 272a due to differences in software code execution times. Likewise, the duration of the Sleep Period 271a can be different than Sleep Period 272b in order to account for differences in Wake Period 272a and Wake Period 272b while still keeping the Interval 273 constant. While in this example only two Intervals are shown, IoT device 110a continuously repeats the Interval and cycles between Wake Periods and Sleep Periods indefinitely.

The time line of events for a second IoT device 210b begins with a Reset event 280 for IoT device 110b which can occur at a time different than Reset event 260 for IoT device 110a. Then IoT device 110b transmits a Join Request packet 270 to Gateway 120a. Then Gateway 120a responds by transmitting a Join Acknowledge packet 271 to IoT device 110b. At the time labelled as Get Network Time 286, IoT device 110b transmits a Time Request packet 272 to Gateway 120b. Then Gateway 120a responds by transmitting a Time Acknowledge packet 273 which includes the network time to IoT device 110b. At the time labelled as Update Local Time 287, IoT device 110b updates its local time to match the network time. Then at the time labelled as Wake 282, IoT device 110b “Wakes-Up” and enter its active state to execute software and utilize its hardware to complete a set of defined tasks. At times labelled as Sleep 283, IoT device 110b “goes to sleep” and at the time labelled Wake 284, IoT device 110b “wakes-up”. The period of time labeled as Wake Period 292a begins at the time labelled Wake 282 and ends at the time labeled Sleep 283. The period of time labeled as Sleep Period 291a begins at the time labelled Sleep 283 and ends at the time labeled Wake 284. The period of time labeled as Interval 293 begins at the time labelled Wake 282 and ends at the time labeled Wake 284.

The period of time between the time labelled Wake 284 and the time labelled Sleep 285 is a second Wake Period 292b. The period of time between the time labelled Sleep 285 and the time labelled Wake 288 is a second Sleep Period 291b. The period of time between the time labelled Wake 284 and the time labelled Wake 288 is the Interval 293. The duration of Wake Period 292b can be different than Wake Period 292a due to differences in software code execution times. Likewise, the duration of the Sleep Period 291a can be different than Sleep Period 291b in order to account for differences in Wake Period 292a and Wake Period 292b while still keeping the Interval 273 constant. While in this example only two Intervals are shown, IoT device 110b continuously repeats the Interval and cycles between Wake Periods and Sleep Periods indefinitely.

In the example of FIG. 2, events on IoT device 110a and events on IoT device 110b are not synchronized. The times labelled as Wake 262 and Wake 264 on IoT device 110a are not synchronized with the times labelled as Wake 282 and Wake 284 on IoT device 110b. Many things contribute to the events on IoT device 110a and on IoT device 110b not being synchronized, such as: (1) IoT device 110a gets a Reset event 260 at a different time than IoT device 110b gets a Reset event 280; (2) packet transmission times may vary for Join Request packets 250 and 270, Join Acknowledge packets 251 and 271, Time Request Packets 252 and 272, and Time Acknowledge packets 253 and 273; (3) IoT device 110a and 110b and Gateway 120a response to packet reception times may vary; and, (4) even if the software code executed on IoT device 110a is identical to IoT device 110b, software code execution times may vary due to variation in Operating System (OS) tasks running on each IoT device 110a and 110b.

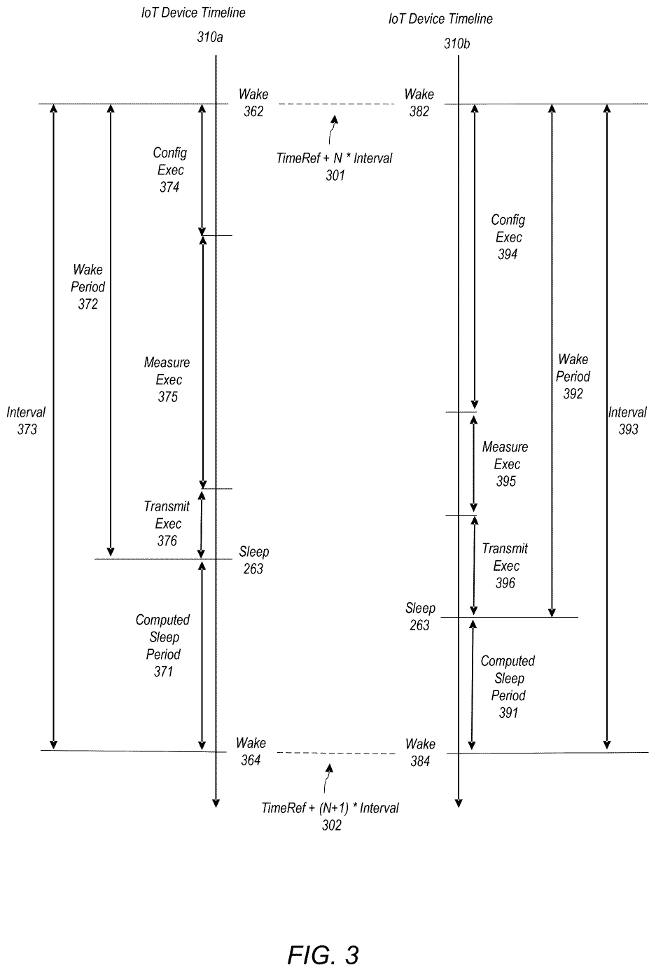

FIG. 3 illustrates an example detailed time line of events in the execution of two IoT devices where some events have been synchronized to an Absolute Time Reference. FIG. 3 illustrates the time line of events for a first IoT device 310a and the time line of events for a second IoT device 310b. For example, the time line of events for a first IoT device 310a could correspond to the events on IoT device 110a. The time line of events for a second IoT device 310b could correspond to the events on IoT device 110b.

The time line of events for the first IoT device 310a shows an Interval 373 which contains a Wake Period 372 and a Computed Sleep Period 371. The Wake Period 272 is further divided into software code execution periods. The Wake Period 372 is divided into a Configuration Execution Period 374, a Measurement Execution Period 375, and a Transmit Code Execution Period 376. The Wake Period may contain additional or different or less code execution periods than are shown in this example.

The Configuration Execution Period 374 is the period of time when the processor in the IoT device executes the software code to configure the IoT device hardware in order to take sensor measurements or to read sensor measurements over an interface. The length or duration of the Configuration Execution Period 374 primarily depends on the number of instructions to be executed to configure the IoT device hardware. However, the duration can also vary to a lesser extent, since the software code can make OS function calls which can have a variable response time or the software code can access IoT device hardware which can have a variable response time. The length of the Configuration Execution Period 374 can be determined by software reading the current time at the start of the Configuration Execution Period 374 and reading the current time at the end of the Configuration Execution Period 374 and subtracting. The length of the Configuration Execution Period is called the ConfigExecPeriod.

The Measurement Execution Period 375 is the period of time when the processor in the IoT device executes the software code to actually take sensor measurements or to actually read sensor measurements over an interface. The length or duration of the Measurement Execution Period 375 primarily depends on the number of instructions to be executed to take sensor measurements or read sensor measurements over an interface. However, the duration can also vary to a lesser extent, since the software code can make OS function calls which can have a variable response time or the software code can access IoT device hardware which can have a variable response time. The length of the Measurement Execution Period 375 can be determined by software reading the current time at the start of the Measurement Execution Period 375 and reading the current time at the end of the Measurement Execution Period 375 and subtracting. The length of the Configuration Execution Period is called the Measure ExecPeriod.

The Transmit Execution Period 376 is the period of time when the processor in the IoT device executes the software code to transmit uplink packets with sensor measurements or other data to the Gateway. The length or duration of the Transmit Execution Period 375 primarily depends on the number of instructions to be executed to transmit uplink packets. However, the duration can also vary to a lesser extent, since the software code can make OS function calls which can have a variable response time or the software code can access IoT device hardware which can have a variable response time. The length of the Transmit Execution Period 376 can be determined by software reading the current time at the start of the Transmit Execution Period 376 and reading the current time at the end of the Transmit Execution Period 376 and subtracting. The length of the Transmit Execution Period is called the TransmitExecPeriod.

The Computed Sleep Period 371 is similar to Sleep Period 271a, 271b, however, the equation to compute the Computed Sleep Period 371 is altered to result in the times labelled as Wake 362 and Wake 364 of IoT device of time line 310a to be synchronized to an Absolute Time Reference.

An Absolute Time Reference is a particular date and time, generally, in the past. For example, Jan. 1, 2023 at 12:00 Midnight can be an absolute time reference or Nov. 1, 2022 at 5:01 PM can be an absolute time reference. The Absolute Time Reference when expressed as a numerical value in seconds since the Epoch is called TimeRef. The Current Time when the Computed Sleep Period 371 is calculated and expressed as a numerical value in seconds since the Epoch is called CurrTime.

The Computed Sleep Period 371 is calculated using the following equations:

$$NextWakeTime = TimeRef + Interval * RoundUp ( ( CurrTime - TimeRef ) / Interval ) \\ ComputedSleepPeriod = NextWakeTime - CurrTime$$

By using this formula for the Computed Sleep Period 371, as long as Wake Period 372 is less than the Interval 373, the time labelled as Wake 362 can be expressed as (TimeRef+N*Interval) 301 and the time labelled as Wake 364 can be expressed as (TimeRef+ (N+1)*Interval) 302, where N is a positive integer.

The time line of events for the second IoT device 310b shows an Interval 393 which contains a Wake Period 392 and a Computed Sleep Period 391. The Wake Period 392 is further divided into software code execution periods. The Wake Period 292 is divided into a Configuration Execution Period 394, a Measurement Execution Period 395, and a Transmit Code Execution Period 396. The Wake Period may contain other or different code execution periods than are shown in this example. The Configuration Execution Period 394 can be different than the Configuration Execution Period 374, the Measurement Execution Period 395 can be different than the Measurement Execution Period 375, and the Transmit Execution Period 396 can be different than the Transmit Execution Period 376, however, if Interval 373 and Interval 393 are the same and if the same Absolute Time Reference is used in the equation for the Computed Sleep Period 391, then the time labelled Wake 382 will be the same as the time labelled Wake 362 and the time labelled Wake 384 will be the same as the time labelled Wake 364. If these above stated requirements are met, then the Wake times for an IoT device associated with time line 310a and an IoT device associated with time line 310b will be synchronized within the accuracy of the local time on each IoT device.

Synchronizing Wake times in multiple IoT devices or synchronizing Wake times in an IoT device to an Absolute Time Reference may be beneficial, but in order to make the sensor measurements meaningful and useful across a large system, synchronizing the time of the measurement is highly desirable. Since IoT devices may be connected to different types of sensors or interfaces, the Configuration Execution Period, the Measurements Execution Period, and the Transmit Execution Period can differ for different types of sensors or interfaces and therefore synchronizing the Wake time does not result in the sensor measurements being taken at the same time. In addition, even in situations where the Configuration software code, the Measurement software code, and the Transmit software code are identical between two IoT devices, differences in packet transmission or reception times or OS activity on the IoT devices may cause the software execution periods to vary.

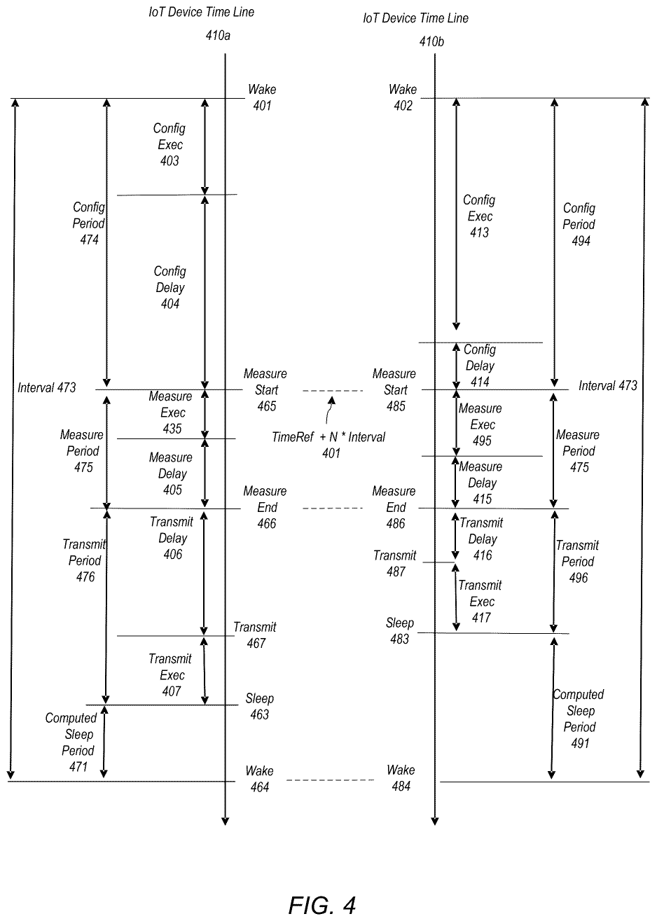

FIG. 4 illustrates an example detailed time line of events in the execution of two IoT devices where sensor measurements and packet transmissions have been synchronized to an Absolute Time Reference, in various embodiments, providing the improved synchronization of measurement noted above. FIG. 4 illustrates the time line of events for a time line of events first IoT device 410a and the time line of events for a second IoT device 410b. The time line of events for a first IoT device 410a could correspond to the events on IoT device 110a. The time line of events for a second IoT device 410b could correspond to the events on IoT device 110b.

The time line of events for the first IoT device 410a shows an Interval 473 which starts at the time labelled as Wake 402 and ends at the time labelled Wake 464. The Interval 473 is divided into a Configuration Period 474, a Measurement Period 475, a Transmit Period 476, and a Computed Sleep Period 471. The Interval may contain additional or different or less periods than are shown in this example.

The Configuration Period 474 starts at the time labelled Wake 401 and ends at the time labelled Measure Start 465. The length or duration of the Configuration Period 474 is a configuration setting for the IoT device used for synchronization of events. The Configuration Period 474 is divided into a Configuration Execution Period 374 and a Configuration Delay Period 404.

The Configuration Delay Period 404 is a period of time where the processor on the IoT device stalls execution for a period of time such as executing a No Operation (NOP) instruction or goes to sleep (e.g., enters a low power mode) for a fixed period of time such as 100 microseconds or 0.000 seconds or 1.250 seconds, for example. The length of the Configuration Delay Period 404 is called the ConfigDelayPeriod and it is computed by software during execution using the following equation:

$$ConfigDelayPeriod = ConfigPeriod - ConfigExecPeriod$$

The Measurement Period 475 starts at the time labelled Measurement Start 465 and ends at the time labelled as Measurement End 466. The length or duration of the Measurement Period 475 is a configuration setting for the IoT device used for synchronization of events. The Measurement Period 475 is divided into a Measurement Execution Period 375 and a Measurement Delay Period 405.

The Measurement Delay Period 405 is a period of time where the processor on the IoT device stalls execution for a period of time such as executing a No Operation (NOP) instruction or goes to sleep (e.g. enters a low power mode) for a fixed period of time such as 100 microseconds or 0.000 seconds or 1.250 seconds, for example. The length of the Measurement Delay Period 405 is called the MeasDelayPeriod and is computed by software during execution using the following equation:

$$MeasDelayPeriod = MeasPeriod - MeasExecPeriod$$

The Transmit Period 476 starts at the time labelled as Measure End 466 and ends at the time labelled Sleep 463. The Transmit Period 476 is divided into a Transmit Execution Period 407 and a Transmit Delay Period 406.

The Transmit Delay Period 406 is a period of time where the processor on the IoT device stalls execution for a period of time such as executing a No Operation (NOP) instruction or goes to sleep (e.g. enters a low power mode) for a fixed period of time such as 100 microseconds or 0.000 seconds or 1.250 seconds, for example. The length or duration of the Transmit Delay Period 406 is a configuration setting for the IoT device used for synchronization of events.

In another embodiment, each IoT device that is to be synchronized to the same Absolute Reference Time and using the same Interval can be assigned a unique number called NodeNumber, the values of which start from 1. The PacketTransmitDelay is an IoT device configuration parameter for event synchronization which represents the amount of time to send one or more packets. The length or duration of the Transmit Delay Period 406 is then computed using the following equation:

$$TransDelayPeriod = ( NodeNumber - 1 ) * PacketTransmitDelay$$

The Computed Sleep Period 471 is similar to Sleep Period 371, however, the equation to compute the Computed Sleep Period 471 is altered to result in the times labelled as Measure Start 465 to be synchronized to an Absolute Time Reference. In this way, the actual sensor measurements will be synchronized to an Absolute Time Reference.

The Computed Sleep Period is calculated using the following equations:

$$NextWakeTime = RefTime + Interval * RoundUp ( ( CurrTime - RefTime ) / Interval ) ) \\ ComputedSleepPeriod = NextWakeTime - CurrTime - ConfigPeriod$$

By using this formula for the Computed Sleep Period 471, as long as the summation of the Configuration Period 474, the Measurement Period 475, and the Transmit Period 476 is less than the Interval 273, the time labelled as Measure Start 465 can be expressed as (TimeRef+N*Interval) 401 and the subsequent Measure Start (not shown in FIG. 4) can be expressed as (TimeRef+(N+1)*Interval), where Nis a positive integer.

The time line of events for the second IoT device 410b shows an Interval 473 which starts at the time labelled as Wake 402 and ends at the time labelled Wake 484. Note that in some embodiments, the wake times of different IoT devices do not have to be the same, and may be different, without affecting the ability of the IoT devices to perform synchronized measurement. The Interval 473 is divided into a Configuration Period 474, a Measurement Period 475, a Transmit Period 496, and a Computed Sleep Period 491. The Interval may contain additional or different or less periods than are shown in this example. The Interval 273, Configuration Period 474, and Measurement Period 475 may be the same for IoT device 110b as they are for IoT device 110a, while the Transmit Periods 476 and 496 are of different lengths and the Computed Sleep Period 471 and 491 are of different lengths.

The Configuration Period 494 starts at the time labelled Wake 402 and ends at the time labelled Measure Start 485. The length or duration of the Configuration Period 494 is a configuration setting for the IoT device used for synchronization of events (e.g., provided as part of a measurement configuration as discussed below). The Configuration Period 494 is divided into a Configuration Execution Period 413 and a Configuration Delay Period 414. The Configuration Execution Period 413 can be different in length than the Configuration Execution Period 403 and the Configuration Delay Period 414 can be different in length than the Configuration Delay Period 404.

The Configuration Delay Period 414 is a period of time where the processor on the IoT device stalls execution for a period of time such as executing a No Operation (NOP) instruction or goes to sleep (e.g., enters a low power mode) for a fixed period of time such as 100 microseconds, 0.000 seconds or 1.250 seconds, for example. The length of the Configuration Delay Period 414 is called the ConfigDelayPeriod and it is computed by software during execution using the following equation:

$$ConfigDelayPeriod = ConfigPeriod - ConfigExecPeriod$$

The Measurement Period 475 starts at the time labelled Measurement Start 485 and ends at the time labelled as Measurement End 486. The length or duration of the Measurement Period 475 is a configuration setting for the IoT device used for synchronization of events. The Measurement Period 475 is divided into a Measurement Execution Period 495 and a Measurement Delay Period 415. The Measurement Execution Period 495 can be different in length than the Configuration Execution Period 435 and the Configuration Delay Period 415 can be different in length than the Configuration Delay Period 405.

The Measurement Delay Period 415 is a period of time where the processor on the IoT device stalls execution for a period of time such as executing a No Operation (NOP) instruction or goes to sleep (e.g., enters a low power mode) for a fixed period of time such as 100 microseconds or 0.000 seconds or 1.250 seconds, for example. The length of the Measurement Delay Period 415 is called the MeasDelayPeriod and is computed by software during execution using the following equation:

$$MeasDelayPeriod = MeasPeriod - MeasExecPeriod$$

The Transmit Period 496 starts at the time labelled as Measure End 486 and ends at the time labelled Sleep 483. The Transmit Period 496 is divided into a Transmit Execution Period 496 and a Transmit Delay Period 416. The Transmit Period 496 can be different in length than the Transmit Period 476 and the Transmit Execution Period 396 can be different in length than the Transmit Execution Period 376 and the Transmit Delay Period 416 can be different in length than the Transmit Delay Period 406.

The Transmit Delay Period 416 is a period of time where the processor on the IoT device stalls execution for a period of time such as executing a No Operation (NOP) instruction or goes to sleep (e.g., enters a low power mode) for a fixed period of time such as 100 microseconds or 0.000 seconds or 1.250 seconds, for example. The length or duration of the Transmit Delay Period 416 is a configuration setting for the IoT device used for synchronization of events.

In another embodiment, each IoT device that is to be synchronized to the same Absolute Reference Time and using the same Interval can be assigned a unique number called NodeNumber, the values of which start from 1. The PacketTransmitDelay is an IoT device configuration parameter for event synchronization which represents the amount of time to send one or more packets. The length or duration of the Transmit Delay Period 416 is then computed using the following equation:

$$TransDelayPeriod = ( NodeNumber - 1 ) * PacketTransmitDelay$$

The Computed Sleep Period 491 is similar to Sleep Period 391, however, the equation to compute the Computed Sleep Period 491 is altered to result in the times labelled as Measure Start 485 to be synchronized to an Absolute Time Reference. In this way, the actual sensor measurements will be synchronized to an Absolute Time Reference.

The Computed Sleep Period is calculated using the following equations:

$$NextWakeTime = RefTime + Interval * RoundUp ( ( CurrTime - RefTime ) / Interval ) ) \\ ComputedSleepPeriod = NextWakeTime - CurrTime - ConfigPeriod$$

By using this formula for the Computed Sleep Period 491, as long as the summation of the Configuration Period 474, the Measurement Period 475, and the Transmit Period 496 is less than the Interval 473, the time labelled as Measure Start 485 can be expressed as (TimeRef+N*Interval) and the subsequent Measure Start (not shown in FIG. 4) can be expressed as (TimeRef+(N+1)*Interval), where N is a positive integer.

By giving multiple IoT devices (e.g., 110a and 110b) the same values for the configuration settings for synchronization of TimeRef, ConfigPeriod, and MeasPeriod and different values for the configuration setting TransmitDelay, sensor measurements on IoT devices will occur at the synchronized instant in time (based on local time) and packets transmitted by each IoT device will occur at different times (based on local time) so as to not collide.

In another embodiment, by giving each IoT device the same values for the configuration settings for synchronization of TimeRef, ConfigPeriod, MeasPeriod, and PacketTransmitDelay and different by assigning unique numbers to each IoT device, sensor measurements on IoT devices will occur at the synchronized instant in time (based on local time) and packets transmitted by IoT devices will occur at different times (based on local time and the unique number) so as to not collide.

The embodiments disclosed above synchronize the reading of sensors and staggers the transmission of packets to avoid collision, achieving the improvements to battery life noted above, based on the local time maintained in the Real Time Clock (RTC) of each IoT device. However, the local time maintained by an RTC can be subject to slight time drifts due to many reasons such as temperature variation, mismatch of RTC components, crystal overdrive, noise coupling, etc. For the local time to be meaningful and useful, the local time being used by each device in a network should be approximately the same. Approximately the same means that the time maintained by each network device is similar to within an acceptable degree of difference. Differences in time that are outside of the acceptable degree of difference may cause measurements to occur at different instances in time which may give a false sense of the state of the system.

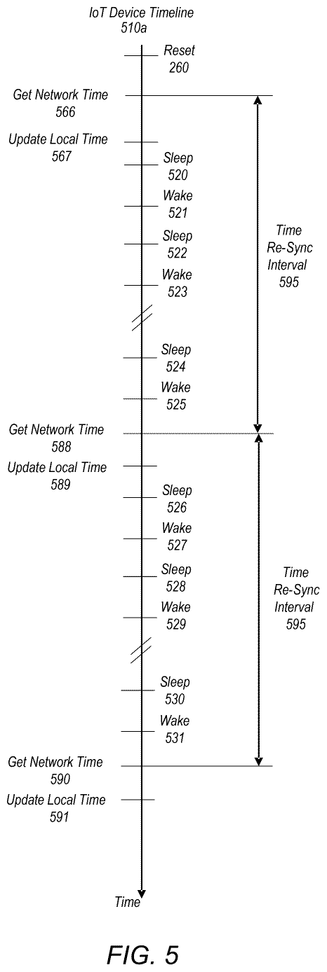

FIG. 5 illustrates an example time line of events in the execution of a single IoT device where local time is re-synchronized to the network time regularly, according to some embodiments. FIG. 5 illustrates the time line of events for a first IoT device 510a which corresponds to the events on IoT device 110a. The time line of events for a first IoT device 510a begins with a Reset event 260 which is the restarting of software execution caused by powering on the device, by pushing a reset button, or by receiving a downlink telling the device to restart software execution.

At a time labelled as Get Network Time 566, the time line for an IoT device (e.g., IoT device 110a) transmits a packet to request the network time. At a time labelled as Update Local Time 567, IoT device 510a receives a packet containing the network time and updates the local time maintained in the RTC on IoT device 510a to match the network time.

At times labelled Sleep 520, Wake 521, Sleep 522, Wake 523, IoT device 510a goes through a series of Intervals (Wake Periods and Sleep Periods). Then after some period of time passes which may be 1 hour, 24 hours, 1 week, or any amount of time, at times labelled as Sleep 524 and Wake 525, IoT device 510a continues its Intervals.

At a time labelled as Get Network Time 588, IoT device 510a transmits a packet to request the network time. At a time labelled as Update Local Time 589, IoT device 510a receives a packet containing the network time and updates the local time maintained in the RTC on IoT device 510a to match the network time.

At times labelled Sleep 526, Wake 527, Sleep 528, Wake 529, IoT device 510a goes through a series of Intervals (Wake Periods and Sleep Periods). Then after some period of time passes which may be 1 hour, 24 hours, 1 week, or any amount of time, at times labelled as Sleep 530 and Wake 531, IoT device 510a continues its Intervals.

At a time labelled as Get Network Time 590, IoT device 510a transmits a packet to request the network time. At a time labelled as Update Local Time 591, IoT device 510a receives a packet containing the network time and updates the local time maintained in the RTC on IoT device 510a to match the network time.

A first Time Re-Sync Interval 595 starts at the time labelled as Get Network Time 566 and ends at the time labelled Get Network Time 588 and a second Time Re-Sync Interval 595 starts at the time labelled as Get Network Time 588 and ends at the time labelled Get Network Time 590. The length or duration of the Time Re-Sync Interval 595 is a configuration setting for IoT device 510a which defines the period of time between Get Network Time requests. The length of the Time Re-Sync Interval 595 can be configured to be 1 hour, 24 hours, 1 week, or any amount of time. Only two Time Re-Sync Intervals are shown, but the Time Re-Sync Intervals continue indefinitely.

By configuring the Time Re-Sync Interval 595 to cause IoT device 510a to regularly re-synchronize its local time maintained in the RTC to match the network time, the impact the time drifts of the RTC can be minimized such that the reading of sensors and staggering of the transmission of packets to avoid collision is effectively becomes based on the network time to which all IoT devices in the network can synchronize.

As discussed above, the configuration period, measurement period, and transmit period may be provided as a measurement configuration to IoT devices in order to ensure measurement synchronization. Different techniques may be implemented to determine these periods to include in the measurement configuration. For example, the IoT device, executing software code implementing the configuration instructions to configure the IoT device's hardware for taking sensor measurements or reading sensor measurements over an interface may captured, record, or otherwise determine the amount of time it takes to execute the software code to perform the configuration instructions as the configuration time. Determining the amount of time that it takes to execute the software code may, for example, be performed by reading the local time just before the execution of the software code and reading the local time just after the execution of the software code and determining the difference between the two local times. This difference may be the amount of time it takes to execute the software code to configure an IoT device's hardware for taking sensor measurements or reading sensor measurements over an interface and may be the configuration time for that IoT device.

The IoT device may implement similar techniques to determine the measurement times and the transmission times for the IoT device. For example, the IoT device executing software code to take sensor measurements or read sensor measurements over an interface may determine the amount of time it takes to execute the software code to take or read sensor measurements as the measurement time. Determining the amount of time that it takes to execute the software code may be performed by reading the local time just before the execution of the software code and reading the local time just after the execution of the software code and determining the difference between the two local times. The amount of time indicated by the difference that it takes to execute the software code to take sensor measurements or read sensor measurements over an interface may be the measurement time for that IoT device. The IoT device executing software code to transmit sensor measurements in packets may determine the amount of time that it takes to execute the software code to transmit sensor measurements as the transmit time. Determining the amount of time that it takes to execute the software code may be performed by reading the local time just before the execution of the software code and reading the local time just after the execution of the software code and determining the difference between the two local times. The amount of indicated by the difference to execute the software code to transmit sensor measurements in packets may be the Transmit time for that IoT device.

Each IoT device may use the same, similar, or different configuration times, measurement times, and/or transmit times. To ensure synchronization, the configuration period, measurement period, and transmit period (also respectively referred to as the Configuration Execution Period, the Measurement Execution Period, and the Transmit Execution Time) may be determined based on the collected times from the IoT devices to be synchronized. For example, the longest respective configuration times, measurement times, and transmit times may be used to determine a configuration period, measurement period, and transmit period to provide in a measurement configuration to IoT devices. In some embodiments, a sensor controller or other system may be used to coordinate the collection of different configuration times, measurement times, and/or transmit times, select or otherwise determine the configuration period, measurement period, and transmit period, and provide the measurement configuration including these times to each IoT device.

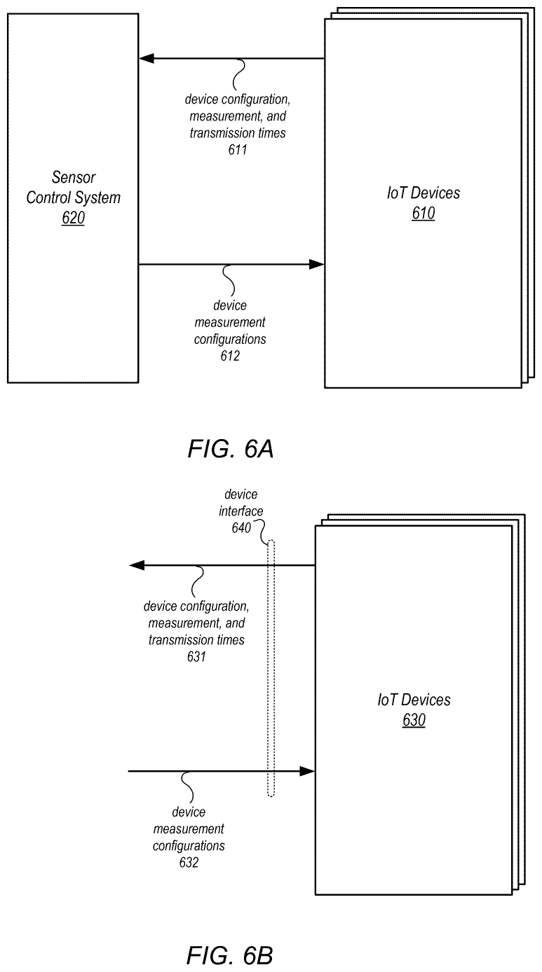

For example, FIG. 6A illustrates a sensor control system 620, which may be implemented as part of (or connected to) a network through which IoT devices, like IoT devices 610 (which may be similar to IoT devices 110 in FIG. 1) are connected (e.g., network 100). Sensor control system 620 may request and/or receive individual device configuration, measurement, and transmission times 611 from IoT devices 610. As discussed above, sensor control system 620 can determine a configuration period, measurement period, and transmission period applicable to all of IoT devices 610 to provide as a device measurement configurations 612. In some embodiments, sensor control system 620 can determine different measurement configurations that are applicable to different subsets of IoT devices 610, so that each sub-set may have a configuration period, measurement period, and transmission period selected based on the times received from that sub-set of IoT devices.

IoT devices may also support a device interface that allows for each IoT device to be configured directly as well as to directly obtain information to perform measurement configuration. For example, in FIG. 6B, IoT devices 630 (which may be similar to IoT devices 110 in FIG. 1) may implement device interface 640 (e.g., a display with user interface, a port to connect IoT devices as a peripheral device, such as over a Universal Serial Bus (USB), a wireless based interface, such as Bluetooth, etc.) via which requests and/or un-prompted information, such as individual device configuration, measurement, and transmission times 631 from IoT devices 630, may be provided. As discussed above, a configuration period, measurement period, and transmission period applicable to all of IoT devices 630 may be provided as device measurement configurations 632 via interface 640 (e.g., via user interface requests, programmatic requests over a connection to another device, or wireless requests).

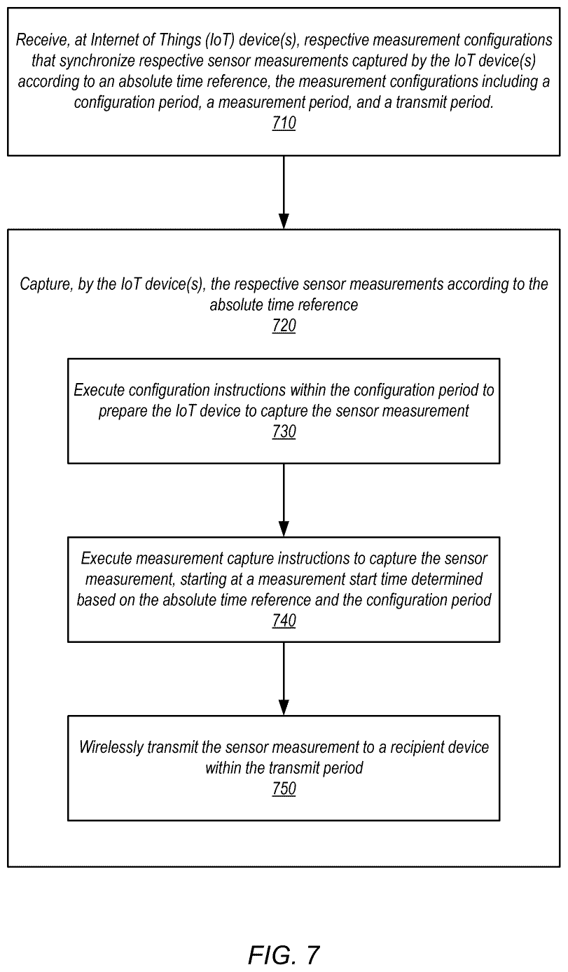

FIG. 7 illustrates an example of a process where synchronization settings can be determined in order to synchronize events on multiple IoT devices.

As indicated at 710, respective measurement configurations may be received at one or more IoT devices, in some embodiments. For example, as discussed above with regard to FIGS. 6A and 6B, these measurement configurations may be provided by sensor control system (or other centralized distribution system), or may be provided directly to individual IoT devices (e.g., through on device interfaces). The measurement configuration may synchronize the measurements captured by the IoT device(s) according to an absolute time reference. The measurement configurations may include a configuration period, a measurement period, and a transmit period. Measurement configurations may include further information such as staggered transmission times or numbered assignments to cause staggered transmission times to avoid collisions. The absolute time reference may be specified in the measurement configuration or may be hardcoded into the software code that is executed on IoT devices to capture sensor measurements.

As indicated at 720, the IoT device(s) may capture the respective sensor measurements according to the absolute time reference, in some embodiments. For example, as indicated at 730, configuration instructions may be executed within the configuration period to prepare the IoT device to capture the sensor measurement. As discussed in detail above with regard to FIG. 4, upon wake, IoT devices may execute the configuration instructions and then determine a configuration delay period (e.g., ConfigDelayPeriod=ConfigPeriod−ConfigExecPeriod). As indicated at 740, the measurement capture instructions may be executed to capture the sensor measurement, starting at a measurement time determined based on the absolute reference time and the configuration period, in some embodiments. As discussed in detail above with regard to FIG. 4, measurement execution (e.g., capture of the measurement) may begin at the synchronized measure start time after which each IoT device may wait the remaining time in the measurement period according to a determined delay (e.g., MeasDelayPeriod=MeasPeriod−MeasExecPeriod).

As indicated at 750, the sensor measurement may be wirelessly transmitted to a recipient device within the transmit period, in some embodiments. As discussed above with regard to FIG. 4, a transmission delay may be determined for (at least some) IoT devices, using a node number (or other assignment information), such as by TransDelayPeriod=(NodeNumber−1)*PacketTransmitDelay.

This technique may be repeatedly performed according to determined wake times. At various times, IoT devices may get network time to update local time, as discussed in detail above with regard to FIG. 5, in order to prevent clock drift from de-synchronizing measurements.

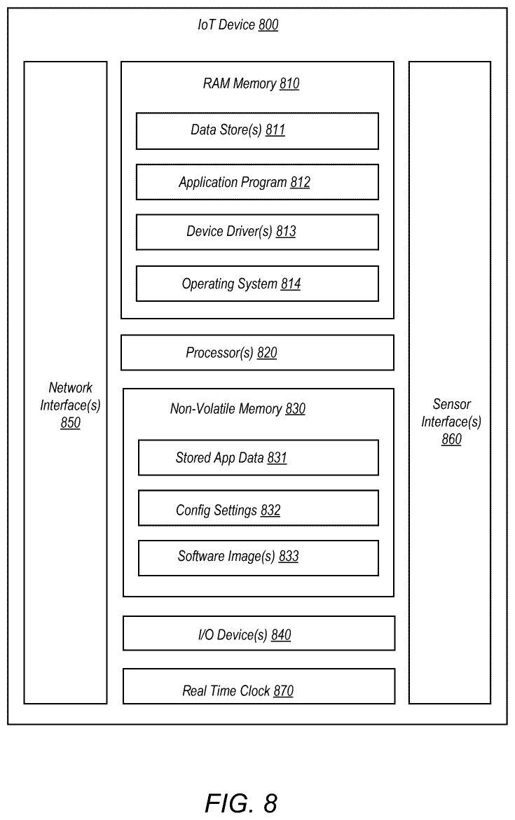

FIG. 8 illustrates an example of an IoT device according to certain aspects of the disclosure. In one example configuration, the IoT device 800 provides a more detailed view of the IoT devices 110a-110d of FIG. 1.

IoT device 800 may include at least one RAM Memory 810 and one or more Processor(s) 820. The Processor(s) 820 may be implemented in a System-on-a-Chip (SoC), Application Specific Integrated Circuits (ASIC), Field Programmable Gate Array (FPGA), hardware module, computer-executable instructions, firmware, or any combination thereof. Computer-executable instructions, firmware implementations of the Processor(s) 820 may include computer-executable or machine-executable instructions written in any suitable programming language to perform various functions described.

In some instances, the hardware Processor(s) 820 may be a single core processor or a multi-core processor. A multi-core processor may include multiple processing units within the same processor. In some embodiments, the multi-core processor may share certain resources, such as buses and second or third level caches. In some instances, each core in a single or multi-core processor may also include multiple executing logical processors (or executing threads). In such a core (e.g. those with multiple logical processors), several stages of the execution pipeline and also lower level caches may be shared.

The RAM memory 810 may store Application Programs 812 or program instructions that are loadable and executable on the processor(s) 820, as well as Data Stores 811 generated during the execution of these programs. The Memory 810 may include an Operating System 814, and one or more Device Driver(s) 813, and/or services for implementing the features disclosed herein.

The Operating System 814 may support basic functions, such as scheduling tasks, executing applications, and/or controller peripheral devices. Examples of operating systems include a real time operating systems like MBED OS, FreeRTOS, Nucleus, RT-Linux, Windows 10 IoT or the like or a standard operating system like Unix, Linux, Windows, Mac OS, iOS, or Android. The Operating System 814 may also be a proprietary operating system.

The Data Stores 811 may include permanent or transitory data used and/or operated on by the Operating System 814, Application Programs 812, or Device Driver(s) 813. Examples of such data include sensor measurement data, sensor measurement calculations, sensor calibration tables, web pages, video data, audio data, images, user data, and so on. The information in the Data Stores 811 may, in some implementations, be provided over the network(s). In some cases, the Data Stores 811 may additionally or alternatively include stored application programs and/or drivers. Alternatively, or additionally, the Data Stores 811 may store standard and/or proprietary software libraries, and/or standard and/or proprietary application user interface (API) libraries. Information stored in the Data Stores 811 may be machine-readable object code, source code, interpreted code, or intermediate code. The Device Driver(s) 813 include programs that may provide communication between components in an IoT device. For example, some Device Driver(s) 813 may provide communication between the operating system 814 and a Non-Volatile Memory/Memories 830, a Network Interface(s) 850, I/O Device(s) 840, a Real Time Clock 870, and/or Sensor Interface(s) 860. Alternatively, or additionally, some Device Drivers 813 may provide communication between Application Programs 812 and the Operating System 814, and/or Application Programs 812 and peripheral devices accessible to the IoT device 800. In many cases, the Device Driver(s) 813 may include drivers that provide well-understood functionality (e.g. display drivers, solid state device drivers, serial interface drivers, network interface drivers). In other cases, the Device Drivers(s) 813 may provide proprietary or specialized functionality.

IoT device 800 may also include Non-Volatile Memory/Memories 830 which may include Stored Application Data 831, Configuration Settings 832, and/or Software Image(s) 833. The Non-Volatile Memory 830 may be comprised of flash memory, one-time-programmable memory, solid state disks, ROM, EEPROM, or the like. The Non-Volatile Memory/Memories 830 may provide non-volatile storage of computer-readable instructions, data structures, program modules, and other data for the computing device.

IoT device 800 may also include I/O device(s) 840 such as push-buttons, switches, LEDs, relays, displays, speakers, a keyboard, a mouse, and the like.

IoT device 800 may also include Network Interface(s) 850 that allow IoT device 800 to communicate with gateways, network servers, other IoT devices, stored databases, operator systems or terminals, and/or other devices on the network. IoT device 800 may communicate to multiple devices and on multiple networks and using multiple protocols. Examples of protocols that Network Interface(s) 850 may support are LoRaWAN, WiFi, Bluetooth, NFC, or the like.

IoT device 800 may also include Sensor Interfaces(s) 860 which may connect to one or more different types of sensors (such as thermocouples, level sensors, distance sensors, pressure sensors, flow sensors, switch position sensors, etc) or interfaces to sensors or data (such as ModBus, CAN bus, etc.).

IoT device 800 may also include a Real Time Clock (RTC) 870 which is an integrated circuit or a sub-component of an integrated circuit or SoC that measures the passage of time and maintains the current date and time. The time maintained by the RTC is the local time. Most RTCs use a quartz crystal oscillator and most RTC's use a crystal that oscillates at a frequency of 32.768 kHz.

The specification and drawings are, accordingly, to be regarded in an illustrative rather than a restrictive sense. It will, however, be evident that various modifications and changes may be made thereunto without departing from the broader spirit and scope of the disclosure as set forth.

Other variations are within the spirit of the present disclosure. Thus, while the disclosed techniques are susceptible to various modifications and alternative constructions, certain illustrate embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure.

The use of terms “a” and “an” and “the” and similar referents in the context of describing the disclosed embodiments are to be construed to cover both the singular and the plural, unless otherwise indicated herein or clearly contradicted by context. The terms “comprising,” “having,” “including,” and “containing” are to be construed as open-ended terms (e.g., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed.

Disjunctive language such as the phrase “at least one of X, Y, or Z”, unless specifically stated otherwise is intended to be understood within the context as used in general to present that an item, term, etc., may be either X, Y, or Z or any combination thereof (e.g., X, Y, and/or Z). Thus, such disjunctive language is not generally intended to, and should not, imply that certain embodiments require at least one of X, at least one of Y, or at least one of Z to each be present.

Various embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited. Moreover, any combination of the above-described elements in all possible variations thereof is encompassed by the disclosure unless otherwise indicated herein or otherwise clearly contradicted by context.

What is claimed is:

1. A system, comprising:
one or more Internet of Things (IoT) devices, respectively comprising at least one processor, a memory;
wherein the one or more IoT devices are configured to:
receive respective measurement configurations that synchronize respective sensor measurements captured by the one or more IoT devices according to an absolute time reference, wherein the respective measurement configurations comprise:
a configuration period;
a measurement period; and
a transmit period;
capture the respective sensor measurements according to the absolute time reference, wherein to capture the respective sensor measurements, the one or more IoT devices are configured to:
execute configuration instructions within the configuration period to prepare the one or more IoT devices to capture the sensor measurement;
execute measurement capture instructions to capture the sensor measurement, starting at a measurement start time determined based on the absolute time reference and the configuration period; and
wirelessly transmit the sensor measurement to a recipient device within the transmit period.

2. The system of claim 1, wherein a first IoT device of the one or more IoT devices has a first wake time that is different from a second wake time of a second IoT device of the one or more IoT devices.

3. The system of claim 1, wherein to capture the respective sensor measurements, the one or more IoT devices are further configured to determine respective delays after completing the configuration instructions, wherein the execution of the measurement capture instructions begins after the respective delays.

4. The system of claim 1, wherein to capture the respective sensor measurements, the one or more IoT devices are further configured to determine respective delays after completing the measurement capture instructions, wherein the respective transmit periods begin after the respective delays.

5. The system of claim 1, wherein to capture the respective sensor measurements, the one or more IoT devices are further configured to determine respective delays prior to wirelessly transmitting the sensor measurement according to device-specific delay assignments provided to the one or more IoT devices as part of the respective measurement configurations, wherein different ones of the one or more IoT devices receive different device-specific delay assignments.

6. The system of claim 1, wherein the one or more IoT devices are further configured to:
obtain respective network times from a network server; and
update respective local times of the one or more IoT devices based on the respective network times, wherein the capture of the respective sensor measurements is performed based on the respective local times of the one or more IoT devices.

7. The system of claim 1, wherein the measurement configuration is received wirelessly from a network server that communicates with one or more of the plurality of IoT devices.

8. A method, comprising:
receiving, at one or more Internet of Things (IoT) devices, respective measurement configurations that synchronize respective sensor measurements captured by the one or more IoT devices according to an absolute time reference, wherein the respective measurement configurations comprise:
a configuration period;
a measurement period; and
a transmit period;
capturing, by the one or more IoT devices, the respective sensor measurements according to the absolute time reference, comprising:
executing configuration instructions within the configuration period to prepare the one or more IoT devices to capture the sensor measurement;
executing measurement capture instructions to capture the sensor measurement, starting at a measurement start time determined based on the absolute time reference and the configuration period; and
wirelessly transmitting the sensor measurement to a recipient device within the transmit period.

9. The method of claim 8, wherein a first IoT device of the one or more of IoT devices has a first wake time that is different from a second wake time of a second IoT device of the one or more of IoT devices.

10. The method of claim 8, wherein capturing the respective sensor measurements further comprises determining respective delays after completing the configuration instructions, wherein the execution of the measurement capture instructions begins after the respective delays.

11. The method of claim 8, wherein capturing the respective sensor measurements further comprises determining respective delays after completing the measurement capture instructions, wherein the respective transmit periods begin after the respective delays.

12. The method of claim 8, wherein capturing the respective sensor measurements further comprises determining respective delays prior to wirelessly transmitting the sensor measurement according to device-specific delay assignments provided to the plurality of IoT devices as part of the respective measurement configurations, wherein different ones of the one or more IoT devices receive different device-specific delay assignments.

13. The method of claim 8, further comprising:
obtaining, by the one or more IoT devices, respective network times from a network server; and
updating, by the one or more IoT devices, respective local times of the one or more IoT devices based on the respective network times, wherein the capture of the respective sensor measurements is performed based on the respective local times of the one or more IoT devices.

14. The method of claim 8, wherein the measurement configuration is received wirelessly from a network server that communicates with one or more of the one or more IoT devices.

15. One or more non-transitory, computer-readable storage media, storing program instructions that when executed on or across one or more computing devices cause the one or more computing devices to implement an Internet of Things (IoT) device that implements:
receiving a measurement configuration that synchronizes respective sensor measurements captured by a plurality of IoT devices, including the IoT device, according to an absolute time reference, wherein the measurement configuration comprises:
a configuration period;
a measurement period; and
a transmit period;
capturing a sensor measurement according to the absolute time reference, wherein in capturing the sensor measurement, the program instructions cause the IoT device to implement:
executing configuration instructions within the configuration period to prepare the IoT device to capture the sensor measurement;
executing measurement capture instructions to capture the sensor measurement, starting at a measurement start time determined based on the absolute time reference and the configuration period; and
wirelessly transmitting the sensor measurement to a recipient device within the transmit period.

16. The one or more non-transitory, computer-readable storage media of claim 15, wherein, in capturing the sensor measurement, the program instructions cause the IoT device to further implement determining a delay after completing the configuration instructions, wherein the execution of the measurement capture instructions begins after the respective delays.

17. The one or more non-transitory, computer-readable storage media of claim 15, wherein, in capturing the sensor measurement, the program instructions cause the IoT device to further implement determining a delay after completing the measurement capture instructions, wherein the transmit period begins after the delay.

18. The one or more non-transitory, computer-readable storage media of claim 15, wherein in capturing the sensor measurement, the program instructions cause the IoT device to further implement determining a delay prior to wirelessly transmitting the sensor measurement according to device-specific delay assignment provided to the IoT device as part of the measurement configuration, wherein the different ones of the plurality of IoT devices receive different device-specific delay assignments.

19. The one or more non-transitory, computer-readable storage media of claim 15, storing further program instructions that when executed by the one or more computing devices, cause the IoT device to further implement:
obtaining a network time from a network server; and
updating a local time of the IoT device based on the network time, wherein the capture of the sensor measurement is performed based on the local time of the IoT device.

20. The one or more non-transitory, computer-readable storage media of claim 15, storing further program instructions that when executed by the one or more computing devices, cause the IoT device to further implement determining a sleep period after completing the transmit period determine a next wake for the IoT device to capture a next sensor measurement.
